(19) United States
(12) Patent Application Publication
(10) Pub. No.: US 2005/0278215 A1
(43) Pub. Date: Dec. 15, 2005

(54) Consumer reward system

(76) Inventor: Norvell Douglas Seele Jr, Saugus, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/491,297

(22) PCT Filed: Mar. 14, 2003
(86) PCT No.: PCT/US03/07817

§ 371 Date: Apr. 23, 2004

(51) Int. Cl. G06F 17/60

(52) U.S. Cl. 705/14

(57) ABSTRACT

Reward system and related methods (100) used to compensate people for time spent participating in activities, in particular, time spent in activities (130) that people generally do not enjoy such as standing in line, providing answers to survey questions, and viewing and/or listening to advertisements. Such a reward system (100) may advantageously use a portable user interface device (300) adapted to allow a holder of the device (300) to interact with the reward system. Such a device may be adapted to allow a holder of the device to interact with multiple reward systems. Data relating to activity participation may be stored internally (320) in such a device (300), and/or may be temporarily stored in such a device and later be transmitted by the device to another device.

This application claims the benefit of U.S. provisional application No. 60/388,500 filed on Jun. 14, 2002 incorporated herein by reference in its entirety.

### FIELD OF THE INVENTION

The field of the invention is consumer reward systems.

### SUMMARY OF THE INVENTION

The present invention is directed to an activity duration reward system (“ADRS”) and the method it embodies. An activity duration reward system is a system that compensates people for time spent participating in activities (“activity duration”), in particular, time spent in activities that the person generally does not enjoy such as standing in line, providing answers to survey questions, and viewing and/or listening to advertisements. Such a reward system may advantageously use a portable user interface device (“PUID”) adapted to allow a holder of the device to interact with the reward system. A PUID may be adapted to allow a holder of the device to interact with multiple reward systems so as to link such reward systems together as sub-systems of a larger ADRS. PUIDs will generally be electronic devices, and preferred PUIDs will be electronic devices than can wirelessly communicate with other portions of an ADRS.

By rewarding people for participation in activities, the described ADRS encourages such participation. Alternatively, by providing negative rewards/punishments for participation, the described ADRS discourages such participation. As such, the described ADRS may be advantageously used by any entity that seeks to encourage or discourage participation in activities. As an example, an ADRS can be used in a theme park to either encourage park customers to wait in line for a ride even if doing so will take a significant amount of time, or to encourage park customers to make use of less desirable rides so as to achieve a better distribution of customers among all the rides in the park. As another example, a store may help defray customer irritation at having to wait for goods or services, or to return items, by rewarding them for the wait. In such an instance the store might may also make use of the time customers are waiting in line by encouraging them to complete survey questions while waiting. In yet another example, a local chamber of commerce may utilize an ADRS to encourage people to shop at local stores and to utilize local service providers. In still another example, an ADRS may be used to encourage people to view or listen to advertising material. In another example, an ADRS may be used by a railroad or other transportation company to compensate passengers who have suffered a delay, such as a delay caused by a breakdown or by routing problems. In yet another example, a store may choose to compensate customers for time spent having to return to the store for an previously out of stock item.

The structure of an ADRS and the functionality it provides will vary depending on the goal the ADRS is to be used to accomplish. Regardless of the structure of an ADRS, an ADRS must be able to at least (a) determine when someone is participating in an activity of interest; (b) identify any such person; (c) determine how long the person participates in the activity. In some instances, (a) and (c) will be combined in that all that must be determined is whether there was any participation in a particular activity by a person. ADRSs will generally also comprise relationships between incentives and activity durations, as well as means for people to receive incentives.

The method used to determining when someone is participating in an activity of interest will generally vary on the type of activity, and the type of activities that are of interest will- generally vary depending on the goal to be accomplished. In some instances, the activity may simply be entering or leaving a store or other location such as a register or ride line. In such an instance, determining when someone is participating in the activity may only require determining when the person passes through an entrance and/or exit. If the location is not an enclosed one, determining when someone is participating in the activity may require monitoring the persons position over time and evaluating whether that position is at the location, or within an area if the location comprises more than a single position. In other instances the participation in an activity may not be determinable simply by monitoring the position of the person. In such instances determining when the person is participating may be facilitated by interaction of the person with the ADRS.

It is contemplated that ADRSs may vary in regard to whether a PUID is used, and in regard to what functionality is provided by the PUID. As such an ADRS may be a PUID-Free ADRS (“PF ADRS”) that does not utilize a PUID, a Dumb-PUID ADRS (“DP ADRS”) that utilizes a PUID that does little beyond functioning as the user interface it is, or a Smart-PUID ADRS (“SP ADRS”) that incorporates a lot, or possibly substantially all, of the functionality of the ADRS in the PUID. As an example, a Dumb-PUID might have functionality similar to that of an older telephone handset in that it can receive signals from the body of the phone and convert them into sound for someone using the telephone to listen to, and can convert speech into signals to be passed to the body of the phone for transmission over the phone lines. In contrast, a Smart-PUID would likely at least provide temporary data storage capabilities, and may also provide much of the functionality of a general purpose computer such that it can execute instructions provided in the form of software applications.

In instances where determining when a person is participating in an activity is facilitated by interaction of the person with the ADRS, the use of a PUID can provide the means for the person interacting with the ADRS. As an example, determining whether someone is listening or viewing advertising material may be facilitated by having the advertising prompt the user to push a button or otherwise manipulate a PUID to interact with the ADRS. Failure to interact in such a manner is an indication that the person is not actually listening or viewing the advertising.

Similarly, if the activity is participation in a survey, use of a PUID to answer the questions indicates that the person is participating. Even though the use of a PUID may not be required to determine when a person is participating in an activity, it will generally provide a simple and economic method for doing that makes the use of ADRS having PUIDS (SP ADRSs and DP ADRSs) more preferred than the use of ADRSs that don't have PUIDS (PF ADRSs).

DP ADRSs and SP ADRSs are also preferred over PF ADRSs because the use of a PUID provide a mechanism for directing ADRS output to individuals. Thus, if advertising material is to be viewed or listened to, providing each person with a PUID can provide a mechanism for simultaneously providing deferent advertising to different people. Providing custom advertising is generally desirable as any such advertising can be customized based on the person that will receive it, the current location of the person that will receive it, the past activities and/or purchases of the person that will receive it, and can be customized based on other criteria as well.

The use of a PUID also simplifies the process of identifying people in that PUIDs can be made to be individually identifiable, and be assigned to individuals such that identification of a PUID is equivalent to identifying a person.

In some instances PUIDs will facilitate determining how long a person participates in an activity of interest by recording when certain events occur so that durations can be determined, or by recording the durations themselves. In doing so a PULID may utilize an internal clock if it has one, or may access an external time source. An external time source may simply provide the current time, or may actually provide the appropriate duration.

It is contemplated that preferred ADRSs may provide incentives in the form of points that can be redeemed for goods, services, AND/OR discounts in a manner similar to the accumulation and redemption of airline miles. The relationships between incentives and activity durations can vary between ADRSs.

ADRSs will generally accumulate sets of activity duration triplets where each triplet comprises an identifier identifying a person the triplet relates to, an identifier identifying an activity, and a duration indicating how long the identified person engaged in the identified activity. In preferred ADRSs, such triplets will be stored in tables of a relational database with each triplet being part of a record of stored in a table, but less preferred ADRSs may utilize other storage mechanisms such as hierarchical databases and flat files.

ADRSs may be divided between ADRSs which actively monitor individuals to determine activity durations (“active ADRSs”, and ADRSs which utilize information generated by participation to determine activity durations (“passive ADRSs”). To illustrate, active monitoring may be accomplished by assigning a person to watch a person being monitored and having the assigned person keep track of what activities the monitored person did and how much time was spent doing each activity. An example of passive monitoring would be a system that utilizes a “timecard model” in which a person carries the equivalent of a time card and has the card stamped at various times and locations in order to record activity durations. Another example of passive monitoring would be a system using a “guard key model” where the system is similar to that used by security guards wherein a key is used at various locations to confirm that a guard is at that location at that time.

Whether passive or active, preferred ADRSs will utilize automated means and wireless communications to determine activity durations. Active ADRSs may benefit from the use of SMART-PUIDS, but can easily function without PUIDs or with Dumb-PUIDs. Similarly, ADRSs implementing a guard-key model might also benefit from the use of SMART-PUIDS, but can easily function with DUMB-PUIDS, and could in some instances function without PUIDs. ADRSs implementing a timecard model will generally require the use of Smart-PUIDs as the PUID must be able to store activity duration information.

It is contemplated that many active ADRSs will comprise a mechanism for monitoring consumer positions over time, a mechanism for recording consumer time and position data, and a mechanism for rewarding consumers based on the recorded time and position data. Such an ADRS may also comprise devices such as PUIDs to facilitate the monitoring of people being monitored positions over time, and possibly to facilitate obtaining input from people being monitored. Such systems will typically embody a method of rewarding a person where the method includes (a) monitoring a person within a monitoring area, (b) recording time and position data for the monitored person as the person moves within the monitoring area, (c) using the recorded time and position data to select one or more incentives to offer to the person, and (d) offering the one or more selected incentives to the person. In such a method the monitoring area may be a portion of a structure, an entire structure, a campus comprising a set of related structures, an area defined by geographic boundaries, or an area defined by political boundaries.

More particularly, the monitoring area may be a store, mall, shopping center, amusement park, or city. In such a method, incentives may be selected for many purposes such as compensating the person for time spent waiting for goods and/or services, and to encourage the person to spend more time at certain locations within the monitoring area than at other locations. To help achieve such purposes, the method may also include instructing the person what the person must do to obtain particular incentives. In some instances, a person being monitored may be able to perform other acts, such as answering survey questions, in order to affect the incentives being offered.

Preferred PUIDs are Smart-PUIDs and are preferred to be a cell phone, smart card, or custom device adapted to allow the person to interact with multiple ADRSs. It is preferred that PUIDs be easily usable by all ages irrespective of handicaps or fear of technology. To make it more easily usable a PUID may have only two or three buttons much like a watch, be operable with one hand without having to be viewed while being operated, have functionality that can be explained in 3 minutes or less, have a text mode for hearing impaired or just visual reinforcement, be constructed to be very durable, be capable of multi-day operation without battery recharge, and fit in the palm of a person's hand. The use of a PUID may be made more desirable by making it attractive, and possibly by making it “brand” recognizable. Preferred PUIDs will have a unique identity associated with a particular individual, preferably a person owning the PUID, both to facilitate awarding incentives to the person and to insure that the mechanism has no theft value.

The methods and systems described herein provide a medium for a person's preferences to be queried outside of “online” and paper-based surveys. This is particularly advantageous as it permits such preferences to be obtained while the person is essentially a captured audience because the person must remain in line or is otherwise movement limited.

It is contemplated that when the methods and systems described herein involve obtaining responses to surveys that such surveys may comprise one or more of the following features and/or advantages. Surveys can be multiple choice or simply proximity of user to a location.

Surveys and points accrual are programmable by venue owner and are trivially simple to input.

Surveys and points, etc. must be validated by venue owner upon checkout, so stand-ins are not possible. Survey data is not externally programmable and is date/time dependent, so it cannot be falsified. Users will take the time to respond because they are being compensated for doing so.

It is contemplated that, using an ADRS, commercial entities can maintain their own data- bases and further can retain the compensation system internal to their company. That is, the device can be used as an entity specific card.

Preferred ADRSs provide commercial entities (including but not limited to Theme-parks, retail and wholesale establishments, parades, trade shows and exhibitions, and ships) with electronic means and methods which entice clientele toward expanded use of the commercial entity's facilities. The enticement is the awarding of benefits to the clientele. The benefits, herein referred to as points, are redeemable for goods and services and would be accrued based upon visiting said entities, with optionally additional points for delays encountered when utilizing the services at said entities, and with further points optionally accruable by participating in interactive sessions at said entities. The clientele would be able to participate in the points program by dint of their having purchased a PUID, thus becoming a “user” of the PUID.

Such preferred ADRSs provide PUID users with a monetary incentive, independent of services received, for visiting an entity. Moreover from the perspective of the entity being visited, the ADRSs described herein accommodate registering the participation in an event at the entity by users in transit, as in for example users queued at the entrance to an attraction in a Theme Park, or queued around a sales counter in a department store watching a video on the attributes of some product including optionally electronically participating in a product usage poll imbedded in the video, hence their role in the collection of CRM (customer relations management) data is limited. Moreover, the ADRSs described herein provide facilely for registering users participation where the events at an entity need to be set up on a moment's notice as for example a taste test in an aisle of a grocery store.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a view of a first method embodying the invention.

FIG. 2 is a view of a second method embodying the invention.

FIG. 3 is a schematic view of a system embodying the invention.

FIG. 4A is a top view of a preferred PUID. po FIG. 4B is an architectural block diagram of the device of FIG. 4A.

### DETAILED DESCRIPTION

### Methods

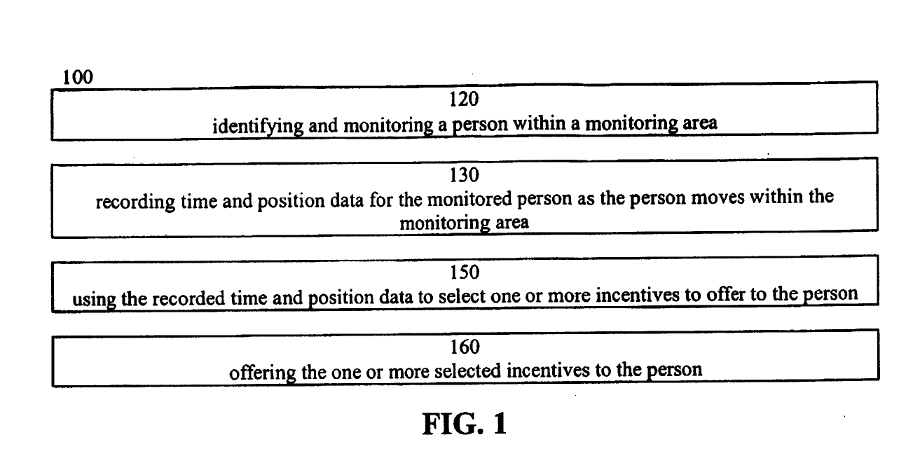

In FIG. 1, an active ADRS method 100 comprises step 120, identifying and monitoring a person within a monitoring area; step 130, recording time and position data for the monitored person as the person moves within the monitoring area; step 150, using the recorded time and position data to select one or more incentives to offer to the person; and step 160, offering the one or more selected incentives to the person.

The monitoring area is limited only to the extent that it must be an area in which a person can be monitored. Contemplated monitoring areas include portions of structures, entire structures, campuses comprising one or more sets of related structures, areas defined by geographic boundaries, and areas defined by political boundaries. It is contemplated that the methods and systems described herein may be particularly advantageous when the monitoring area is a store, mall, shopping center, amusement park, or city.

Step 120, identifying and monitoring a person within a monitoring area may be accomplished in any way known at the times when method 100 is implemented. Various embodiments may use combinations of passive AND/OR active monitoring systems (“MSs”). In some embodiments, a monitoring system (“MS”) capable of monitoring individuals as they move through the monitoring area through the use of video cameras and automated interpretation of the images captured by such cameras may be used. In other embodiments monitoring may be accomplished through the use of a plurality of different type of sensors such as optical, infrared, ultrasonic, pressure, and/or radio frequency (“RF”). In preferred active embodiments a MS that is adapted to track a portable user interface device (“PUID”) carried by a person being monitored is used.

In preferred active methods, MSs will be used that process data from a plurality of sensors to identify the current locations of each person being monitored within the monitoring area. The MSs will preferably provide positions in the form of coordinates, or identifiers associated with sub-areas within the area being monitored. As such, the output of a preferred MS may comprise a stream of person and location identifier pairs.

In preferred passive methods, MSs will comprise one or more access points with monitoring being accomplished by the MS interacting with a PUID carried by a person via such an access point to obtain data on the person's activities. Access points placed near entrances can be used by a person to notify a MS of his or her presence such that the MS can identify the person. Access points placed near exits can be used to notify a MS that he or she is leaving.

Access points placed within an area being monitored can be used to transfer data between the MS and PUIDs.

Step 130, recording time and position data for the monitored person as the person moves within the monitoring area may also be accomplished in any way known at the times when method 100 is implemented. Less preferred methods make use of analog recordings on tape storage devices where the data is recorded as raw signals from sensors and is later subjected to processing to convert the recorded signals into a form suitable for use in incentive selection. As an example, video cameras may be used to make video recordings of the movement of people within a monitoring area and those video recordings would be subsequently processed to derive the data necessary for incentive selection.

In preferred methods, time and position data will be recorded in a processed and compressed form to minimize storage requirements and to minimize the amount of processing subsequently required in making use of such data. In such methods, time and position data may be stored as sets of records associated with individuals comprising a time stamp and a position, where the position may be a set of coordinates, or an identifier associated with an area within the monitored area. As an example, if stored as a table in a relational database time and position data may be stored in a table wherein each record of the table comprises an person ID field identifying the person the record is associated with, a time stamp indicating the time the position was obtained, and a position ID field identifying the position of the person identified by the person ID and the time indicated by the time stamp. Table 1 illustrates such a relational database table: Person ID Time Position ID Smith, Joe 13: 01 Water Ride #1, In line Smith, Joe 13: 02 Water Ride #1, In line Smith, Joe 13: 03 Water Ride #1, In line Smith, Joe 13: 04 Water Ride #1, In line Smith, Joe 13: 05 Water Ride #1, In line Smith, Joe 13: 06 Water Ride #1, On ride Schipp, Nancie 13: 01 Coaster #5, On ride Schipp, Nancie 13: 02 Walkway #15 Schipp, Nancie 13: 03 Concession Stand #1, In line Schipp, Nancie 13: 04 Concession Stand #1, In line Schipp, Nancie 13: 05 Concession Stand #1, In line Schipp, Nancie 13: 06 Concession Stand #1, Dining Area Table 1 It is contemplated that in some instances time data will be converted into durations prior to storage AND/OR prior to use in selection of incentives. Table 2 illustrates the data of Table 1 with the time data converted to a start time and a duration. Person ID Start Duration Position ID Time (minutes) Smith, Joe 13: 01.5 Water Ride #1, In line Smith, Joe 13: 06 1 Water Ride #1, On ride Schipp, Nancie 13: 01 1 Coaster #5, On ride Schipp, Nancie 13: 02 Walkway #15 Schipp, Nancie 13: 03 4 Concession Stand #1, In line Table 2 Alternative embodiments may have time and position data that includes information other than what is shown in tables 1 and 2, and may be stored in a format different from those shown.

Step 150, using the recorded time and position data to select one or more incentives to offer to the person is preferably accomplished via automated means with selection being done in a manner contemplated as helping to achieve a desired goal. It should be noted that the method of selecting incentives is not necessarily limited to a particular method. As such, less preferred methods could involve the use of people reviewing printed time and position data to individually make decisions on what incentives to award. However, preferred automated methods will require operator interaction only in initially specifying, or subsequently modifying, the criteria to be used in selecting incentives.

Specifying and/or modifying selection criteria will preferably be done in a manner to facilitate a desired result. In some instances incentives are selected in a manner to encourage a monitored person to avoid long-delay areas. In other instances, incentives are provided in a manner to encourage customers to seek out or remain in long-delay areas.

Incentives are not limited to any particular form of incentive. As such, both positive incentives such monetary rewards may be used as may be negative incentives such as monetary fines, although preferred methods will utilize at least some positive incentives. Incentives may comprise points that are awarded conditional upon minimum purchase of vendor's products or at the vendor's option in order to assure viable clientele only. Benefits/points are awarded to the consumer based upon time, effort (such as in taking surveys), and purchasing of products.

Awards from previous visits and visits to other venues are redeemable.

Step 160, offering one or more selected incentives to the person may also be accomplished in any way known at the times when method 100 is implemented. In some instances incentives may be delivered directly to individuals such as by sending a check. In other instances, incentives may have to be claimed by a person in a manner requiring the person to go to a redemption location. In still other instances, incentives may be conditional on future acts by the person such as where incentives are discounts that require particular goods be purchased in order for the discounts to be used. In some instances a person may have an option to choose between incentives and thus a method of selection would need to be provided.

In preferred methods, a person to be monitored will be provided with a signaling mechanism adapted to cooperate with a plurality of MSs such that the person can use the signaling mechanism to signal any such MS when to begin monitoring the person and/or when to stop monitoring the person. In such methods, the step of monitoring the person would preferably comprise the use of a MS adapted to receive signals from the signaling mechanism to monitor the signaling mechanism carried by a person within a monitoring area. If usable with a plurality of MSs, a single signaling mechanism can be used in multiple monitoring areas even if the MSs doing the monitoring are not commonly owned. As such, a single mechanism may be useable in a plurality of different stores, in stores and theme parks, or in any other combination of locations that have MSs that the signaling device can cooperate with.

Preferred methods will also include subjecting a person being monitored to stimuli and recording interaction between the person and the signaling mechanism resulting from subjecting the person to the stimuli. In such methods, it is preferred that incentives be awarded based both on time and position data, and on the recorded interaction. As an example, a person waiting in line may be positioned to see a video monitor or other display device being used to display a series of questions that the person can answer via the signaling mechanism. If the person chooses to answer the questions while waiting in line, the person would, in many instances, be provided with a reward for doing so in order to encourage the person to make such a choice. It should be noted that making use of a person's time while he or she is waiting benefits both that person and the entity making use of the time.

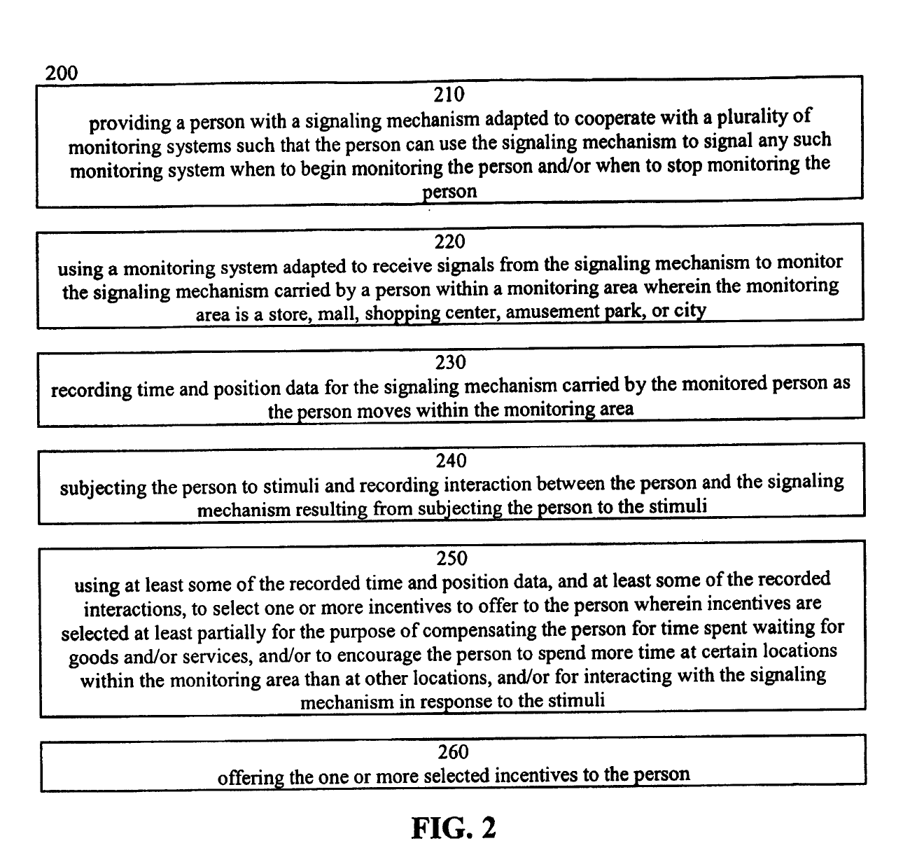

In FIG. 2, an embodiment of method 100 is shown. Method 200 comprises step 210, providing a person with a signaling mechanism adapted to cooperate with a plurality of MSs such that the person can use the signaling mechanism to signal any such MS when to begin monitoring the person and/or when to stop monitoring the person; step 220, using a MS adapted to receive signals from the signaling mechanism to monitor the signaling mechanism carried by a person within a monitoring area wherein the monitoring area is a store, mall, shopping center, amusement park, or city; step 230, recording time and position data for the signaling mechanism carried by the monitored person as the person moves within the monitoring area; step 240, subjecting the person to stimuli and recording interaction between the person and the signaling mechanism resulting from subjecting the person to the stimuli; step 250, using at least some of the recorded time and position data, and at least some of the recorded interactions, to select one or more incentives to offer to the person wherein incentives are selected at least partially for the purpose of compensating the person for time spent waiting for goods and/or services, and/or to encourage the person to spend more time at certain locations within the monitoring area than at other locations, and/or for interacting with the signaling mechanism in response to the stimuli; and step 260 offering the one or more selected incentives to the person. Steps 220,230, 250, and 260 are substantially equivalent to steps 120,130, 150, and 160 of method 100.

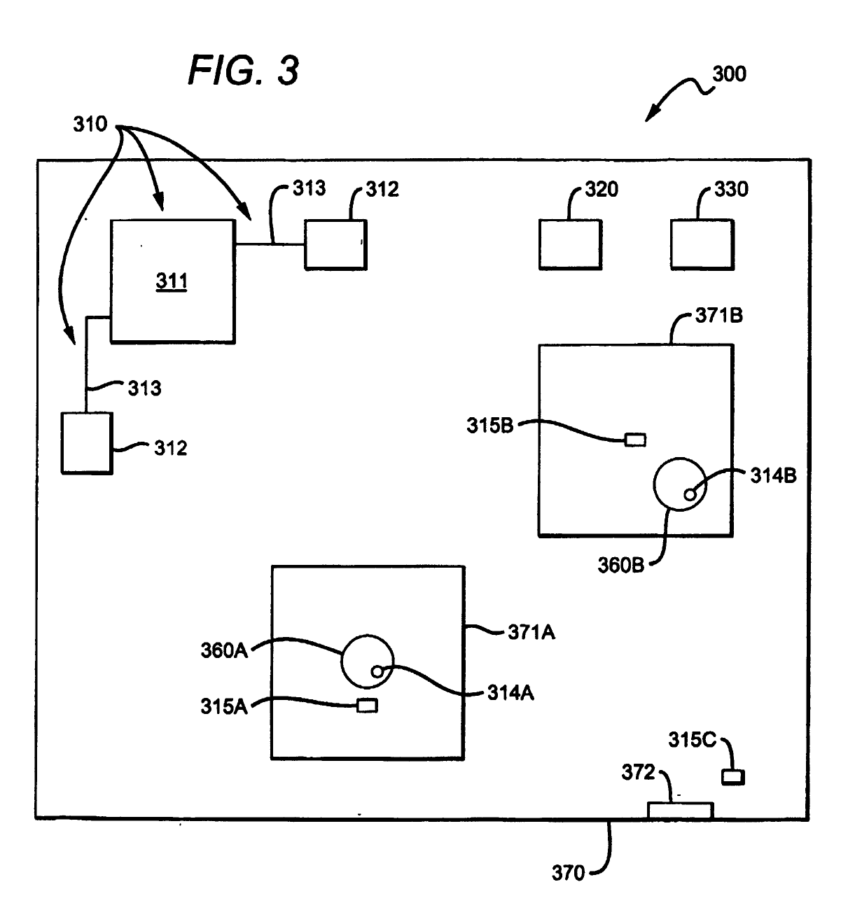

ADRSs In FIG. 3, an active ADRS system 300 adapted to implement the method illustrated in FIG. 1 comprises a MS 310 adapted to monitor people 360A and 360B within the monitoring area 370; a recording system 320 (“RS”) adapted to record time and position data for the monitored people 360A and 360B as each person (360A or 360B) moves within the monitoring area 370; and an incentive system 330 (“IS”) adapted to use the time and position data recorded by recording system 320 to offer one or more selected incentives to the persons 360A and 360B.

Although shown separately, MS 310, RS 320, and IS 330 may, in some instances, be co-located and possibly implemented as a single unit such as in a general purpose computer. Monitoring system 310 comprises a control unit 311, sensors 312, and communication channels 313 that are used to transfer data from sensors 312 to control unit 311. MS 310 is also preferred to comprise PUIDs 313A and 313B carried by people 360A and 360B, and access points 315A, 315B, and 315C. Monitoring area 370 comprises two sub-areas, 371A and 371B, and an entrance/exit 372.

In many instances, a person will be considered to be stationary at a single location even if he or she moves within such a sub-area.

It is contemplated that an ADRS will generally comprise at least one PUID carried by a person, a computer system for system management and operator interfacing tasks as well as for maintaining a database of users who have entered the entity with said PUlDs, and at least one multi-channel access point via which the PUIDs are validated into and out of the entity.

Communication between the multi-channel access point (s) and the computer system could optionally be hard-wired LAN or wireless LAN.

An ADRS will typically comprise a data set made up of a number of data segments with many of the data segments varying in regard to the types of information they contain, their format, where they are stored, and how they are stored. It is contemplated that an ADRS will typically comprise person specific data for each person who is to be rewarded via the ADRS, time and position data that is essentially a log of what activities people have participated in and the duration of such participation (possibly in one of the forms previously described herein), incentive data comprising information on the incentives that can be or have been awarded, and activity-incentive relationship data that defines the relationships between activity durations and incentives to be awarded.

It is contemplated that storage of data acquired and maintained by an ADRS may be stored in a single component of the ADRS, in a subset of components of the ADRS, or in segments spread among all the components of the ADRS. It is also contemplated that the method in which the data is stored will vary depending on where the data is stored. As such, data stored in a PUID may be stored using a solid state memory device whereas data stored in a access point may be stored using some form of magnetic or optical storage, or a combination of solid state, magnetic, and optical media. In preferred embodiments at least some of the data will be stored in a PUID in a manner that helps prevent unauthorized modification of the data.

As previously described, one type of data to be stored is that related to awarded incentives. As incentives are awarded, it is contemplated that they may be stored either internally in the PUID, in another portion of the ADRS, or in an external system. As an example, if the incentives awarded comprise points, a Global Points Validation Site (GPVS) may be used wherein the points could be “banked” for use in any entity participating in the points system.

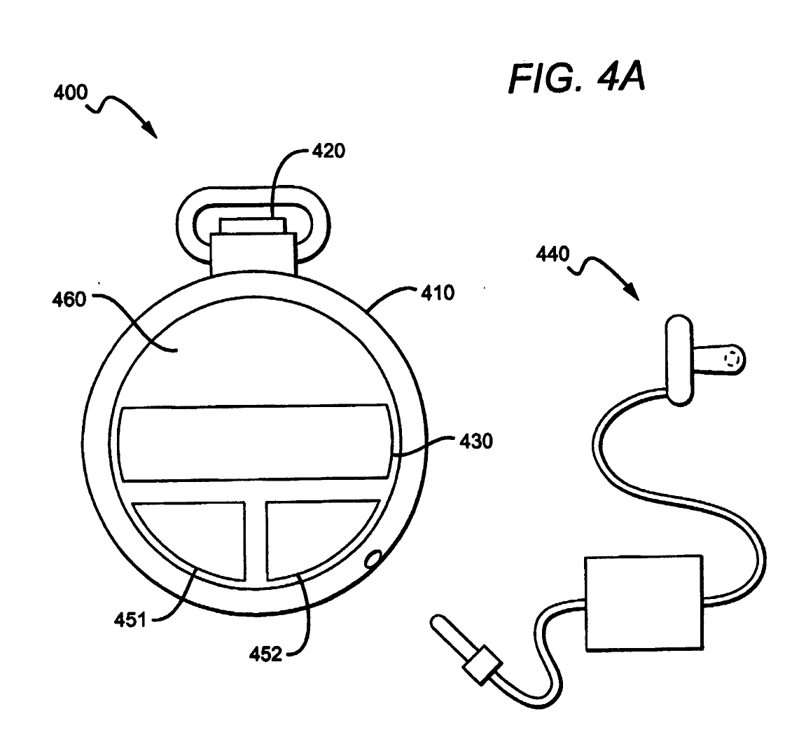

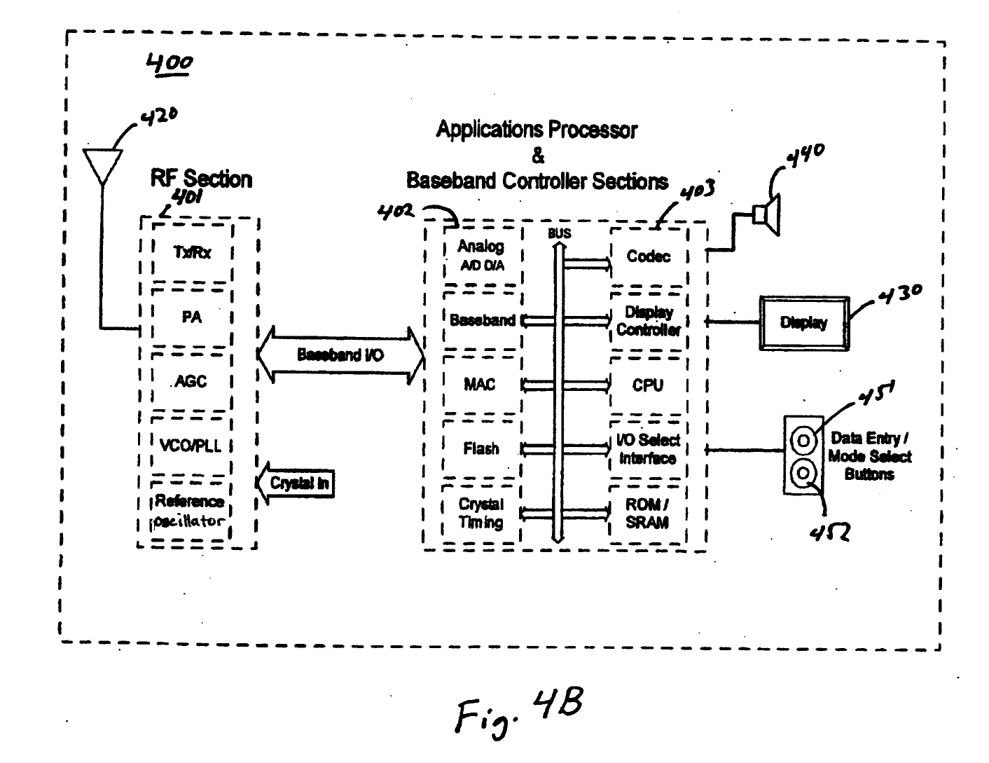

PUIDs A MS of an active ADRS preferably comprises a plurality of Smart-PUIDs such as device 400 of FIGS. 4A and 4B. As shown in FIG. 4A, PUID 400 comprises a case 410, an antenna 420, a display 430, an earpiece 440, input buttons 451 and 452, and a brand display area 460. As shown in FIG. 4B, PUID 400 preferably also comprises RF section 401, baseband controller section 402, and application processor section 403.

The basic functionality of the PUID 400 preferably includes at least supporting the communication and control of audio media and text data received via an access point such as access points 315A-315C in FIG. 3, and delivered to the user via the earpiece and display elements 440 and 430 respectively, the computation of points awarded to the user and accrued within the PUID, and storage of metadata regarding the person in possession of PUID 400, which said data can have points value.

Preferred PUIDs will accrue points/incentives internally where the algorithms defining the computation of points accrued within the PUID are based upon time, the user's location, and the user's response to queries as in for example a game or a survey of the user's recent purchases and stored metadata. A real-time clock resident within the PUID provides the time baseline.

When used in a passive ADRS, a person's location may be known to the PUID as a function of the user having registered into an area and area specific date/time tags received via an access point in said area and by the user's having responded to games or surveys or instructions in said area.

Metadata acquired by a PUID can be but is not limited to, indicators of areas visited, monies spent by said user, and coupons awarded to the user for having made a prior purchase.

The storage of metadata can be either as information usable as parameters in the computations made by the PUID or as encrypted data used by the ADRS.

Preferred PUIDs would comprise a minimum of 1000 storage locations for metadata, further and at least 30 storage locations allocated for long term storage per day of which 3 could be used by any one ADRS. It is contemplated that “long term” storage would be 30 days, on the 30th day of which said day's long term storage locations would be cleared. Further it is preferred that there be roughly 100 short term locations allocated for any one visit to an ADRS and cleared upon exit of said ADRS. In other embodiments, more storage would be available and longer term allocations would be possible, however by limiting the duration and quantity of stored metadata, the effect of losing one's PULID is minimized. Of course storage of metadata at the ADRS and or the GPVS is possible.

Antenna 420 is preferably adapted to provide PUID 400 with the ability to both transmit (“TX”) and receive (“RX”) signals. In some embodiments antenna 420 may be replaced with two or more antennas, possibly with certain antennas dedicated to transmitting and others dedicated to receiving.

Display 430 is preferably LCD based. As with the audio content, the displayed data is that transmitted by a MS with which the PUID has synchronized and which said transmission the PUID has decoded for visual playback to the user. The visual content can optionally include but is not limited to, narrative information relevant to entities in the visual proximity of the user, information regarding sales, and visual cues used to alert or otherwise communicate with the user. In the preferred embodiment a backlit display or equivalent capability to allow reading of the display in low-light environments is recommended, however operation of the PUID without the assistance of the visual display is provided.

The earpiece 440 (or an equivalent transducer element) of PUID 400 is optional, with the preferred embodiment utilizing optionally a self-powered earpiece 440. The audio content being that transmitted by a MS with which the PUID has synchronized and which said transmission the PUID has decoded for audible playback to the user. The audio content can optionally include but is not limited to, narrative information relevant to entities in the visual proximity of the user, music, and audio signals used to alert or otherwise communicate with the user.

FIGS. 4A and 4B also illustrates the preferred embodiment as having two button I/O input capability (buttons 451 and 452) for the PUID via which the user can input responses to queries and effect mode changes in the PUID. One of the buttons can, for example, serve as an enable in a certain mode of operation, wherein the PUID is caused to log changes in state of the second button if the enable button's state is actuated prior to and during the time the second button is being actuated. Additional examples include a certain mode wherein the actuation of the enable button causes the PUID to respond in duplex mode to transmissions it receives. While embodiments utilizing more buttons or equivalent are considered, the preferred embodiment's simplicity of operation increases the probability that the PUID can be used with one hand and much of the time without viewing the PUID, therefore permitting for example, the user's hands to be in his/her pockets, and for the user to be holding a child or package in one hand, and facilitates it's use by visually handicapped individuals.

PUID 400 is intended to be implemented using commercially available chip sets, including optionally those made by Fujitsu or Motorola or Maxell among others. These chip sets can variously support wireless standards inclusive of but not limited to 802.11, HiiperLan2, HomeRF, 802.15. 4 (Zigbee), Bluetooth, and various ISM band standards, any of which can be used in embodiments of this invention, with Zigbee being the preferred embodiment. Depending upon the chip set being utilized, the allocation of functions per chip and the labeling of said functions and the implementation technology and the quantity of chips will vary from that shown and moreover there are functions such as but not limited to the rechargeable battery power supply, that have not been shown.

It contemplated that device 400 may be adapted for one or more of the following uses.

Use as an audio platform for visually impaired or second language. Use to limit audio program distribution to qualified users only (parade float narrations, museums, sales promotional, supplement sales personnel in showrooms, etc. ) Use to validate identity of user via imbedded security chip (employee entrances, hotels, multiple-entry venues like pools or theme parks). Use as a text platform for hearing impaired. Use as toll payment method. Use as an electronic ticket.

Use as a game quiz playing device wherein the guest responds to multiple choice questions (e. g., queue line in theme park, guests waiting for a movie to start, etc. ) Use in any situation necessitating a check-in requirement (night watchmen, people queuing access that is based upon duration of time in line (restaurant, theater, etc). Use as an ID for accessing telephone messages when away from home/office. Use as an “enable/verify” in electronic home to allow programming changes (setting values of various house systems). Use to retain secure personal time-dependent data (prescriptions, entry authorizations, etc.).

Devices 400 are preferably hand held, and may be sized and dimensioned and otherwise adapted to be carried and/or held in the manner of a pocket or wristwatch. Devices 400 will preferably utilize uni-directional (simplex) broadcast mode reception for surveys & games, thus precluding any limit on guest density at a location. Devices 400 will preferably be adapted to permit storage of data (surveys results, game answers, coupons, etc. ) within the devices such that the device need only transmit occasionally.

In some instances PUiDs 400 will transmit only to allow a person to register (log into) a MS via a “wayside” system (a system positioned adjacent to a location a person being monitored can get to), and will preferably have very low transmitted power requiring its antenna be within inches of an access point's antenna, thus precluding interference between hand-held devices and ensuring security of transmissions.

It is contemplated that in many instances a high-speed data link tying a PUID to the rest of an ADRS will not be required. In many instances lower bandwidth connections can be used with repeated transmissions to minimize the risk of lost communications.

It is preferred that more than a device 400 be required to recover any incentives awarded through use of the device so that the device has no theft value.

### EXAMPLE & NUM; 1

In one embodiment, an access point can be used for registering a person into and out of an entity such as a theme park or a retail department store by a person placing a PUID in close proximity to the access point as the person entered or exited the entity. It is preferred in such an embodiment that the output power of the PUID and/or the access point be limited to minimizing any interference with other devices.

### EXAMPLE & NUM; 2

In another embodiment, the access points of an MS can be used within the entity for transmitting data to the user. Such data may, among others, include data corresponding to the correct answers to questions being displayed on a video monitor to the user in a queue line in a theme park, or addresses locations in the PUID's memory for storing the user's choices in a poll the user is responding to in for example a queue at a department store cosmetic counter. In this embodiment, the access point would not have to be within the user's reach and the access point can optionally be transmitting at greater power than when communicating in a duplex mode with the user's PUID.

### EXAMPLE #3

In yet another embodiment, the MS can utilize a wireless LAN for communication among the MS devices. This would allow the access points to be portable for ease of placement as would be desired for example in a retail store where a kiosk may be temporarily set up for a 1 hour sale or as in for example a queue line in a theme park where the entrance to the queue line changes with the length of the line.

### EXAMPLE #4

The minimal operating sequence in a preferred embodiment of the invention would have a user log into the entity by placing, for a period of time of less than a few seconds, the user's PUID over, by less than 6 inches, an access point comprising an access point located in the entry path to or within the entity, while activating a button integral to the PUID. This activation would allow the user's PUID to transmit data to and receive data from said antenna. Said data optionally includes but is not limited to, downloading from the facility side a date/time stamp, and the frequency assignment and Network ID (NWID) and hopping sequence and encryption Initialization Vector (IV) for that facility, and parameters used by the PUID for computing the accruing of award points.

Data downloaded from the user's PUID optionally includes but is not limited to the identification code of the PUID, user metadata, and self-check validation data ensuring the PUID is working correctly.

The user would then utilize the entity for its purpose, for example shopping for clothing, and upon checking out at a POS location, the user would in the preferred embodiment of the invention pass the PUID over a similar type of access point as noted at the entrance, which would exchange data optionally including but not limited to, downloading from the user's PUID the date/time stamp, and data indicating which locations within the facility the user had visited and the user's duration at said locations and the results of any polls or games the user had participated in, as well as the user's ID code and points accrued during the visit.

Data uploaded from the facility side could include optionally but not limited to, commands clearing various temporary storage locations as well as resetting the PUID, setting flags or equivalent indicators of a transaction having occurred for use in concert with subsequent visits to the entity or other related entities wherein points are accrued by nature of the said occurrence.

Note that optionally no points are accrued nor are any indicators of a transaction having occurred set, unless a purchase is effected at the POS location. The decision to award points is made optionally, by the operator at the POS location or electronically by the POS system interface to the MS associated with said POS location.

### EXAMPLE #5

When the user of a PUID enters a monitoring area for the first time, the MS associated with the access point via which said user entered, is responsible for registering the user into the ADRS which includes an interactive session wherein the PUID is tested to ensure it is working satisfactorily, the downloading of the information required for the PUID to access other MSs when local to said nodes, and optionally exchanging metadata with said PUID. Successfully completing the entrance process is optionally indicated by a blinking light or beeper or equivalent device within view or hearing respectively of the user.

The metadata from the MS can optionally be encrypted before transfer to the PUID such that it can only be decrypted by the a MS associated with said ADRS or an MS associated with a different ADRS which shares it's encryption KEY. For example a Theme Park or similar commercial entity may have an event to which entrance discounts are afforded to users who purchase something at a local convenience store and then buy an entrance ticket to the Park, in which case the ADRS for the convenience store would store metadata on the user's PUID using an encryption KEY it shares with or is subordinate to the Theme Park's encryption KEY.

After entering the system, the user's ID is optionally verified via a global point validation site (GPVS) such that by the time the user is ready to leave the system the option to bank the points at the GPVS does not delay the user's egress time. Throughout the user's time in the system, metadata indicative of the locations visited or actions taken such as eating lunch at a location within the ADRS are downloaded to the user's handheld via the access point and its associated MS most local to the user.

The point's computation aspect of the application program includes uploading from the PUID the points computed by said PUID, and optionally adding to that calculation a point value associated with metadata uploaded from said PUID. This computation can be a running total updated each time a MS is accessed by the user or minimally by the last MS via which the user exits the ADRS.

### EXAMPLE #6

When the user of a PUID, in this instance optionally a cell phone or PDA, enters a monitoring area for the first time, the MS associated with the access point via which said user entered, is responsible for registering the user into the ADRS which includes optionally exchanging metadata with said PUID via optionally Bluetooth. Said exchange of data could optionally include a JAVA coded program comprising the application under which the PUID would then run. Throughout the user's time in the system, metadata indicative of the locations visited or actions taken at a location within the ADRS are stored within the MS.

The points computation aspect of the application program would reside within the MS. This computation can be a running total updated each time a MS is accessed by the user or minimally by the last MS via which the user exits the ADRS.

### SUMMARY

Thus, specific embodiments and applications of activity duration reward systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method of rewarding a person comprising: identifying a person to be monitored; monitoring the identified person within a monitoring area; recording time and position data for the monitored person as the person moves within the monitoring area; using the recorded time and position data to select one or more incentives to offer to the person; offering the one or more selected incentives to the person.

2. The method of claim I wherein the monitoring area is a portion of a structure, an entire structure, a campus comprising a set of related structures, an area defined by geographic boundaries, or an area defined by political boundaries.

3. The method of claim 2 wherein the monitoring area is a store, mall, shopping center, amusement park, or city.

4. The method of claim 1 wherein the person is a consumer of goods and/or services and incentives are selected for the purpose of compensating the person for time spent waiting for goods and/or services.

5. The method of claim 1 wherein incentives are selected to encourage the person to spend more time at certain locations within the monitoring area than at other locations.

6. The method of claim 1 further comprising instructing the person what the person must do to obtain particular incentives.

7. The method of claim 1 wherein the person can control whether he or she is monitored within the monitoring area.

8. The method of claim 7 wherein the person is provided with a signaling mechanism adapted to cooperate with a monitoring system such that the person can use the signaling mechanism to signal the monitoring system when to begin monitoring the person and/or when to stop monitoring the person.

9. The method of claim 8 wherein the signaling mechanism is adapted to allow the person to send the monitoring system signals in response to stimuli experienced by the person within the monitoring area.

10. The method of claim 9 wherein the signals sent to the monitoring system correspond to answers the person gives to a survey.

11. The method of claim 1 wherein the time and position data consists essentially of how long the person was within the monitored area.

12. A reward system adapted to implement the method of claim 1, wherein the system comprises: a monitoring system adapted to monitor a person within the monitoring area; a recording system adapted to record time and position data for the monitored person as the person moves within the monitoring area; an incentive system adapted to use the recorded time and position data to offer one or more selected incentives to the person.

13. The system of claim 12 wherein the monitoring system is positioned within the monitoring area.

14. The system of claim 12 wherein the recording system is positioned outside of the monitoring area.

15. The system of claim 12 wherein selected incentives comprise points that can be redeemed for goods, services, and discounts on goods and services.

16. The system of claim 12 further comprising a signaling mechanism adapted to be carried by the person being monitored.

17. The system of claim 16 wherein the signaling mechanism is a cell phone or smart card.

18. The system of claim 16 wherein the signaling mechanism is adapted to inform a holder of the mechanism what points the holder has earned using the mechanism

19. A method of rewarding a person comprising notifying the person that they will be compensated for time spent waiting in line, monitoring how long the person spends waiting in line, selecting a form of compensation for the person based on how long they spent in line, and offering the selected compensation to the person.
